(19) United States
(12) Patent Application Publication
(10) Pub. No.: US 2025/0086440 A1
(43) Pub. Date: Mar. 13, 2025

(54) SYSTEM AND METHODS FOR PROCESSING USER INTERACTIONS WITH WEB DOCUMENTS

(71) Applicant: The Toronto-Dominion Bank, Toronto (CA)

(72) Inventors: Isaiah Jared ERB, Waterloo (CA); Samantha Marie Oliveira ESTOESTA, Kitchener (CA); Deep Piyushkumar PARMAR, Etobicoke (CA); Matthew VOLLICK, London (CA)

(73) Assignee: The Toronto-Dominion Bank, Toronto (CA)

(21) Appl. No.: 18/464,696

(22) Filed: Sep. 11, 2023

(51) Int. Cl. G06N 3/0475

(52) U.S. Cl. CPC G06N 3/0475

(57) ABSTRACT

A computer-implemented method is disclosed. The method includes: receiving, via a user device, user selection of text content and a first request to obtain supplementary data associated with the selected text content; determining whether a first database stores preferred supplementary data relating to the selected text content; in response to determining that the first database does not store the preferred supplementary data, providing, to a generative AI model, an input prompt for generating the requested supplementary data, the input prompt including at least a portion of the selected text content; receiving an output of the generative AI model; and providing, to the user device for display thereon, the output.

### TECHNICAL FIELD

The present application relates to web technologies and, more particularly, to a system and methods for processing user interactions with web documents.

### BACKGROUND

Generative artificial intelligence (AI) models are increasingly being used across many domains. Such models (e.g., large language models, etc.) can be used to generate responses conditioned on input of natural language prompts. Various assistive technologies may employ generative AI to improve user access to and comprehension of digital content.

### BRIEF DESCRIPTION OF THE DRAWINGS

Reference will now be made, by way of example, to the accompanying drawings which show example embodiments of the present application and in which:

FIG. 1 is a schematic diagram illustrating an operating environment of an example embodiment;

FIG. 2A is a high-level schematic diagram of an example computing device;

FIG. 2B is a schematic block diagram showing a simplified organization of software components stored in memory of the example computing device of FIG. 2A;

FIG. 3 shows, in flowchart form, an example method of processing text content of a web document for generating supplementary display data in a web browsing session;

FIG. 4 shows, in flowchart form, an example method for processing user interaction with text content of a web document in a web browsing session;

FIG. 5 shows, in flowchart form, an example method for processing user interaction with video content of a web document in a web browsing session;

FIG. 6 shows, in flowchart form, an example method for managing user interface elements of a web document;

FIG. 7 is a sequence diagram illustrating an example process for handling user interactions with web content; and

FIGS. 8A and 8B show examples of the display area of a browser when a browsing enhancement module in accordance with disclosed embodiments is enabled.

Like reference numerals are used in the drawings to denote like elements and features.

### DETAILED DESCRIPTION OF EXAMPLE EMBODIMENTS

In an aspect, a computing system is disclosed. The computing system includes a processor and a memory coupled to the processor. The memory stores instructions that, when executed by the processor, cause the processor to: receive, via a user device, user selection of text content and a first request to obtain supplementary data associated with the selected text content; determine whether a first database stores preferred supplementary data relating to the selected text content; in response to determining that the first database does not store the preferred supplementary data, provide, to a generative artificial intelligence (AI) model, an input prompt for generating the requested supplementary data, the input prompt including at least a portion of the selected text content; receive an output of the generative AI model; and provide, to the user device for display thereon, the output.

In some implementations, the generative AI model may comprise a large language model (LLM).

In some implementations, the supplementary data may comprise at least one of a definition associated with one or more terms included in the selected text content or a summary of the selected text content.

In some implementations, the instructions, when executed, may further cause the processor to: store, in the database, a defined number of preferred definitions for a plurality of terms; receive, via user devices, input of preference indicators in connection with the plurality of terms; and update the stored preferred definitions of the database based on the received input of preference indicators.

In some implementations, updating the stored preferred definitions may include deleting one or more definitions from the database.

In some implementations, updating the stored preferred definitions may include obtaining, via the generative AI model, additional definitions associated with the plurality of terms and storing the additional definitions in the database.

In some implementations, obtaining the additional definitions may include providing, to the generative AI model, an input prompt that includes at least one of the preferred definitions.

In some implementations, the instructions, when executed, may further cause the processor to, prior to providing the input prompt, determine whether a requesting user has a sufficient number of tokens for making the first request, and the input prompt may be provided to the generative AI model only if the requesting user has sufficient number of tokens.

In some implementations, determining whether a requesting user has a sufficient number of tokens may include determining a total count of words included in the selected text content.

In some implementations, the instructions, when executed, may further cause the processor to, after the input prompt is provided to the generative AI model, store, in memory, an updated available token count for the requesting user.

In some implementations, providing the output may include displaying a user interface element containing at least a portion of the output on a graphical user interface.

In some implementations, the selection of text content may include at least a portion of a transcript associated with a video, and the instructions, when executed, may further cause the processor to annotate the video based on the output of the generative AI model.

In some implementations, annotating the video may include generating titles for different sections of the video using the output of the generative AI model and denoting the different sections.

In some implementations, the instructions, when executed, may further cause the processor to display a user interface element for receiving an indication of a desired reading level for the selected text content.

In some implementations, the instructions, when executed, may further cause the processor to receive, via the user device, a modification request to modify the selected text content, the modification request indicating at least one of a language register or intended audience for the modified text.

In some implementations, the instructions, when executed, may further cause the processor to: scan a graphical user interface to identify one or more text input areas; and provide, to a generative AI model, an input prompt for generating suggested text for use in populating the one or more text input areas, and the generative AI model may be trained using previous typed response data of the user.

In another aspect, a computer-implemented method is disclosed. The method may include: receiving, via a user device, user selection of text content and a first request to obtain supplementary data associated with the selected text content; determining whether a first database stores preferred supplementary data relating to the selected text content; in response to determining that the first database does not store the preferred supplementary data, providing, to a generative AI model, an input prompt for generating the requested supplementary data, the input prompt including at least a portion of the selected text content; receiving an output of the generative AI model; and providing, to the user device for display thereon, the output.

In another aspect, a non-transitory computer readable storage medium is disclosed. The computer readable storage medium stores computer-executable instructions that, when executed by a processor, cause the processor to: receive, via a user device, user selection of text content and a first request to obtain supplementary data associated with the selected text content; determine whether a first database stores preferred supplementary data relating to the selected text content; in response to determining that the first database does not store the preferred supplementary data, provide, to a generative artificial intelligence (AI) model, an input prompt for generating the requested supplementary data, the input prompt including at least a portion of the selected text content; receive an output of the generative AI model; and provide, to the user device for display thereon, the output.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, the term “generative AI model” (or simply “generative model”) may be used to describe a machine learning model. A generative AI model may sometimes be referred to, or may use, a language model. A trained generative AI model may respond to an input prompt by generating and producing an output or result. The output/result may be produced by the generative AI model through interpreting the intent and context of the input prompt. In some cases, the generative AI model may be implemented with constraints on the acceptable input prompts. The constraints may, for example, include one or more prompt templates. A prompt template may specify that input prompts have certain structure or constrained intents, or that acceptable prompts exclude certain classes of subject matter or intent, such as the production of results/outputs that are violent, obscene, etc.

Significant advances have been made in recent years in generative AI. Different implementations of generative AI models may be trained to create text, images, or other media (e.g., digital art, etc.). Examples of generative AI models include Stable Diffusion by Stability AI Ltd., ChatGPT by OpenAI, DALL-E 2 by OpenAI, and GitHub CoPilot by GitHub and OpenAI. These models learn patterns and structure of their input training data and generate new data that has similar characteristics.

Complex web content (e.g., complicated text) may be difficult to comprehend for users with cognitive disabilities and/or limited understanding of relevant subject matter. Current tools that assist with content comprehension are typically limited to basic functionalities, or are overly resource-intensive.

In an aspect, the present disclosure provides an adapted web accessibility tool. The accessibility tool is designed to simplify web browsing experience for people of all abilities. In at least some implementations, the accessibility tool leverages use of generative AI models (e.g., ChatGPT) to enhance user access of text content on web documents. The accessibility tool may support improved user interactions with web documents by, for example, outputting customized definitions of user-selected terms and/or summaries of complicated text that is found on webpages.

The proposed accessibility tool is configured to perform analysis of text content of web documents. In some implementations, a user may first need to be authenticated in order to use the accessibility tool. Users may be authenticated upon providing their user credentials. In particular, a computing system (e.g., a backend server) associated with the accessibility tool may perform user authentication. The authentication may be based on an identity protocol (e.g., OpenID Connect) that enables client applications to rely on authentication that is performed by a third-party identity provider for verifying the identity of a user. An ID/access token may be sent to the user's device upon successful authentication. The ID/access token serves to identify the requesting user, and may be transmitted in each request by the user to obtain supplementary data for a web document.

The accessibility tool may be provided by, or as part of, a browsing enhancement module (e.g., a web browser extension). A user may select certain text on a webpage and request, using the accessibility tool, to obtain a definition of one or more selected terms and/or a summary of the selected text content. The computing system may be configured to automatically generate input prompts for providing to a generative model to obtain the definitions/summaries of the selected text. More particularly, the computing system may provide at least part of the selected text in an input prompt to a generative model, with instructions for the generative model to output a suitable definition and/or summary of the selected text. For example, the computing system may produce an input prompt that includes at least a portion of the selected text, and cause an API call to the generative model to be invoked given the input prompt and other request parameters (e.g., maximum number of tokens, temperature (i.e., a measure of randomness of output), language model, etc.).

In at least some implementations, the computing system may perform a check of a database storing definitions for a plurality of terms to determine if the user-selected text is included in the database. In particular, the computing system determines whether there is a stored preferred definition of the user-selected term(s). A “preferred” definition of a term refers to a definition for which one or more users have previously indicated preference. For a given term, users may indicate their preference and/or perceived usefulness of a definition using various input mechanisms (e.g., selection of user interface elements such as thumbs-up/-down icon, etc.). The computing system may track user-inputted preferred definitions data and store the data in association with terms in the database. In some instances, a preferred definition may be a definition that is hard-coded in a database that is accessible by the computing system to override alternative definitions of a term. Technical terminology (i.e., jargon) have specialized meaning in particular fields, such as technology or finance. Various terms of art or industry terms may be associated with specialized definitions. Such definitions may be imported from specific dictionary sources and integrated into the database as preferred definitions.

The computing system may itself be configured to maintain a database of preferred definitions of selected terms. For each stored term, the computing system may maintain a defined number of definitions of the term. Users may be able to rate each definition by, for example, indicating their preference for one or more of the stored definitions. The definitions may be ranked based on the user preference data, and a limited number of preferred definitions of terms may be maintained by the computing system.

For example, only those definitions that are associated with a rating or ranking that exceeds a defined threshold may be stored in the database. Over time, the definitions having the highest ratings/ranking may be prioritized in responding to user requests for definitions of selected terms. If a certain definition (or group of definitions) for a term has a statistically significant rating advantage, the alternative (i.e., non-preferred) definitions may be deleted from the database. The computing system may obtain new definitions of terms and store them in place of the deleted definitions (up to a defined limit on number of definitions). Additionally, or alternatively, the preferred definitions may be used as part of (i.e., included in) input prompts for obtaining new definitions of terms.

If the selected terms are not included in the database or a request is received (from a user) to obtain a definition for the selected term(s) that is different from the stored definitions, the computing system may leverage use of a generative AI model in producing a response to the user request to obtain a definition of selected text. Specifically, the computing system may produce an input prompt for instructing a generative AI model to output a suitable definition for the selected terms.

In at least some implementations, the computing system may track a count of “tokens”, which represent an amount of text that is sent to the generative AI model in an input prompt for obtaining a definition/summary. The tokens represent resource cost for making calls to the generative AI model. As such, the computing system keeps track of token count in order to optimize the cost of retrieving definitions and summaries. In particular, the computing system may allocate a limited number of tokens to each user and track the number of tokens available for making requests to the generative AI model on a per-user basis. For example, each user may be allocated a certain number of tokens for retrieving term definitions and a certain number of tokens for retrieving text summaries. In this way, the number and length of requests (e.g., API calls) to the generative AI model for the purpose of generating supplementary data, such as definitions and summaries, associated with a web document may be controlled by the computing system.

The input prompt to the generative AI model may include at least part of the user-selected text. In some implementations, the computing system may be configured to rank text-containing elements of the webpage according to several metrics, and the top-ranked elements may be provided, with the input prompt, to the generative AI model. For example, when a request is received to provide a summary of the contents of a webpage based on the text within it, the text-containing elements of the webpage may be ranked, for identifying elements which may contribute to the page summary. The metrics may include one or more of: usage of semantic tags; length of content in an element; inclusion of semantic attributes (e.g., alt-text, aria-labels, etc.). The top ranked elements that will contribute to the summary may be selected, and the text data for said elements may be flattened into a single input prompt that is fed to the generative AI model.

After each request to the generative AI model, the computing system may determine a count of tokens used for the input prompt and response, and the available token count for the requesting user may be updated. The definition/summary that is output by the generative AI model may be communicated to the user, for example, via a graphical user interface provided on the user's device. For example, HTML and/or CSS elements may be injected into a web document from which text is selected in order to display a popup (or another UI element) containing the requested definition/summary.

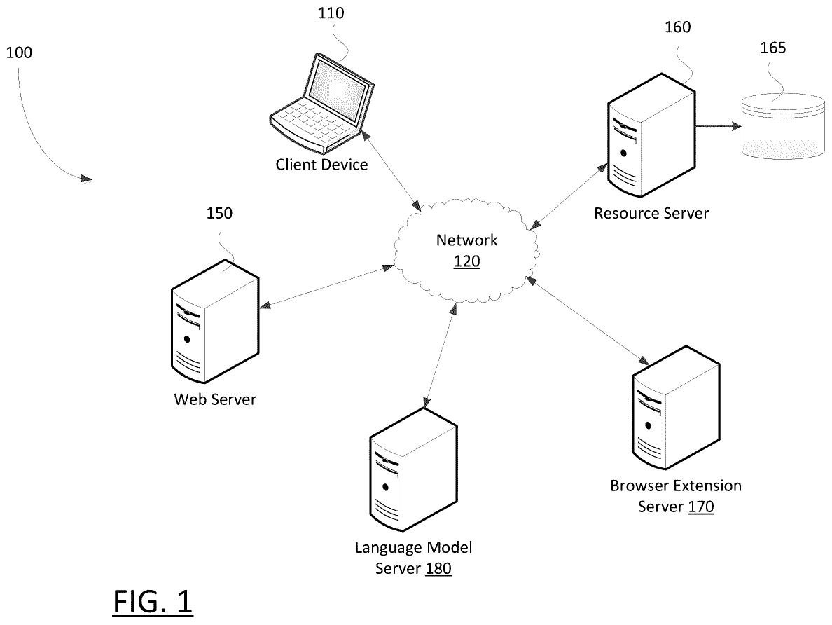

Reference is first made to FIG. 1 which illustrates an example networked environment 100 consistent with certain disclosed embodiments. As shown in FIG. 1, the networked environment 100 may include client devices 110, a web server 150, a resource server 160, a database 165 associated with the resource server 160, a browser extension server 170, a language model server 180, and a communications network 120 connecting various components of the networked environment 100.

The resource server 160 (which may also be referred to as a server computer system) and the client devices 110 communicate via the network 120. In at least some implementations, the client device 110 is a computing device. The client device 110 may take a variety of forms including, for example, a mobile communication device such as a smartphone, a tablet computer, a wearable computer such as a head-mounted display or smartwatch, a laptop or desktop computer, or a computing device of another type. The client device 110 is associated with a client entity (e.g., an individual, an organization, etc.) having resources that are managed by, or using, the resource server 160. For example, the resource server 160 may be a financial institution server and the client entity may be a customer of a financial institution that operates the financial institution server. The client device 110 may store software instructions that cause the client device to establish communications with the resource server 160.

The resource server 160 may be configured to track, manage, and maintain resources, make lending decisions, and/or lend resources to a client entity associated with the client device 110. The resources may, for example, comprise computing resources, such as memory or processor cycles. In at least some implementations, the resources may include stored value, such as fiat currency, which may be represented in a database. For example, the resource server 160 may be coupled to a database 165, which may be provided in secure storage. The secure storage may be provided internally within the resource server 160 or externally. The secure storage may, for example, be provided remotely from the resource server 160. For example, the secure storage may include one or more data centers storing data with bank-grade security.

The database 165 may include records for a plurality of accounts and at least some of the records may define a quantity of resources associated with the client entity. For example, the client entity may be associated with an account having one or more records in the database 165. The records may reflect a quantity of stored resources that are associated with the client entity. Such resources may include owned resources and, in some implementations, borrowed resources (e.g., resources available on credit). The quantity of resources that are available to or associated with the client entity may be reflected by a balance defined in an associated record such as, for example, a bank balance.

In some implementations, the database 165 may store various types of information relating to customers of a business entity that administers the resource server 160. For example, the database 165 may store customer profile data and financial account data associated with customers. The customer profile data may include, without limitation, personal information of registered customers, authentication credentials of the customers, account identifying information (e.g., checking and/or savings account numbers), and information identifying the services (e.g., banking services, investment management services, etc.) and programs that are offered to the customers by the business entity. The financial account data may include portfolio data relating to portfolios of investments that are held by customers. A customer's portfolio data may include, for example, information identifying actual positions held by the customer in various securities, information identifying a “virtual” portfolio composed of simulated positions held by the customer in various securities, and “watch lists” specifying various securities that are monitored by the customer.

The web server 150 serves documents (and other resources), which may be in the form of webpages, to the client device 110. The web server 150 functions as a computing system that stores web server software and a website's component files (e.g., HTML documents, CSS stylesheets, etc.). The web server 150 is configured to process hypertext transfer protocol (HTTP) requests, serving documents and other resources in response to such requests. An HTTP request may be issued, for example, by an application (e.g., a web browser) operating on the client device 110. The documents that are served by the web server 150 may include documents of various types including, for example, text-based documents, multimedia documents, videos, and audio files.

The language model server 180 is configured to implement an AI system. In at least some implementations, the language model server 180 may host a large language model (LLM)-based chatbot, such as ChatGPT. The AI system uses one or more generative models to generate content. The generative model may be an unsupervised or semi-supervised machine learning algorithm that is trained using a set of training data content.

For example, the generative model may comprise an LLM that is based on transformer, a type of neural network architecture. The transformer architecture uses self-attention mechanisms in order to generate predicted output based on input data that has some sequential meaning (i.e., the order of the input data is meaningful, which is the case for most text input). A transformer may be trained on a text corpus that is labelled (e.g., annotated to indicate verbs, nouns, etc.) or unlabelled. Although transformer-based language models are described herein, it should be understood that the present disclosure may be applicable to other ML-based language models, including language models based on other neural network architectures such as recurrent neural network (RNN)-based language models.

LLMs may be trained on large data sets of unlabeled text. Some LLMs may be trained on a large multi-language, multi-domain corpus, to enable the model to be versatile at various language-based tasks, such as generative tasks (e.g., generating human-like responses to natural language input). Input prompts may be provided to the language model server 180, and the generative model may produce outputs related to the input prompts.

The browser extension server 170 is associated with a browsing enhancement module. The browser extension server 170 may comprise one or more computing devices that are configured to perform operations, such as storing and managing data, authenticating users, etc., consistent with providing a browser extension application. While the resource server 160 and the browser extension server 170 are shown separately in FIG. 1, in some implementations, the resource server 160 may include or otherwise be associated with the browser extension server 170. For example, various functions of the browser extension server 170 may be provided, at least in part, by the resource server 160, or vice versa. In particular, the resource server 160 may perform backend services of a browsing enhancement module. Additionally, or alternatively, the browser extension server 170 may be a standalone computing system that is communicably connected to client devices executing a browsing enhancement module.

The client device 110, the web server 150, the resource server 160, the browser extension server 170, and the language model server 180 may be in geographically disparate locations. Put differently, the client device 110 may be remote from at least one of: the web server 150, the resource server 160, the browser extension server 170, and the language model server 180. As described above, the client device 110, the web server 150, the resource server 160, the browser extension server 170, and the language model server 180 may be computer systems.

The network 120 is a computer network. In some implementations, the network 120 may be an internetwork such as may be formed of one or more interconnected computer networks. For example, the network 120 may be or include an Ethernet network, an asynchronous transfer mode network, a wireless network, or the like.

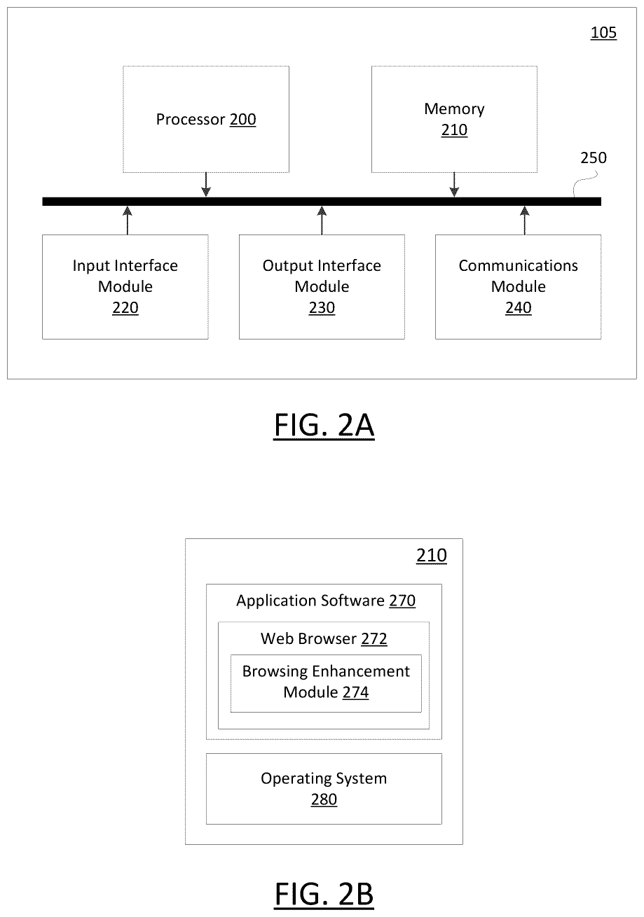

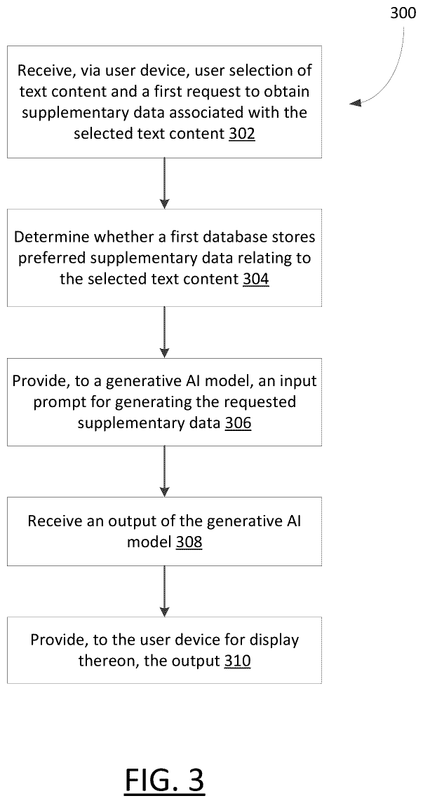

FIG. 2A is a high-level operation diagram of an example computing device 105. In some implementations, the example computing device 105 may be exemplary of one or more of: the client device 110, the web server 150, the resource server 160, the browser extension server 170, and the language model server 180. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. For example, the processor 200 may be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some implementations, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some implementations, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards.

For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi™, using Bluetooth™ or via some combination of one or more networks or protocols. Contactless payments may be made using NFC. In some implementations, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated these software components include an operating system 280 and application software 270.

The operating system 280 is software. The operating system 280 allows the application software 270 to access the processor 200, the memory 210, the input interface module 220, the output interface module 230, and the communications module 240. The operating system 280 may be, for example, Apple IOS™, Google™ Android™, Linux™, Microsoft™ Windows™, or the like.

The application software 270 adapts the example computing device 105, in combination with the operating system 280, to operate as a device performing particular functions. The application software 270 may, for example, include a web browser 272. The application software 270 may also include processor-executable instructions which, when executed by the processor 200, cause the computing device 105 to interact with the resource server 160 as described herein. Such instructions are referred to herein as a browsing enhancement module 274. The browsing enhancement module 274 may, for example, be a software module that is provided on the computing device 105 as an extension of the web browser 272. The browsing enhancement module 274 may enable one or more application services to interface with the web browser 272. For example, the browsing enhancement module 274 may add certain features, enable additional actions, and enhance the functionality of websites that are displayed on the computing device 105 using the web browser 272.

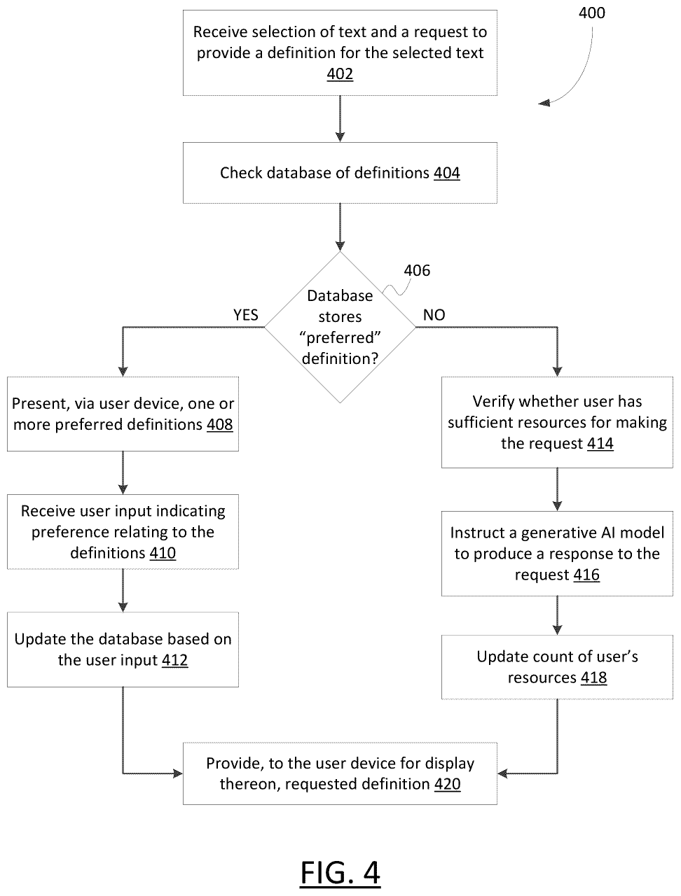

Reference is made to FIG. 3 which shows, in flowchart form, an example method 300 of processing text content of a web document for generating supplementary display data in a web browsing session. In at least some implementations, the method 300 may be implemented as part of a process for providing a user interface for accessing web documents on client devices. In particular, the operations of method 300 may be performed in providing one or more functionalities of a web browser extension that is executed locally on a client device during a web browsing session.

The operations of method 300 may be performed by a client device (e.g., by software resident on the client device), either alone or in conjunction with one or more computer servers. For example, a client device that is used for a web browsing session may perform one or more client-side operations of method 300 and a server, such as the browser extension server 170 of FIG. 1, that acts as a backend for a browsing enhancement module of a web browser may perform certain server-side operations of method 300.

In some implementations, a client device or a server may perform all of the operations of method 300. In particular, computer-executable instructions stored in memory of a client device (or a server computer) may, when executed by a processor of the client device (or server), configure the processor to perform the operations of method 300. The instructions corresponding to the operations of method 300 may be executed, for example, as part of software, such as a web browser and/or a browsing enhancement module, that is operable for providing web browsing sessions on the client device. The description of method 300 provided below refers to a backend server implementing the operations of the method; however, it will be understood that one or more of the operations may be performed locally on a client device, for example, by a browsing enhancement module (e.g., a web browser extension).

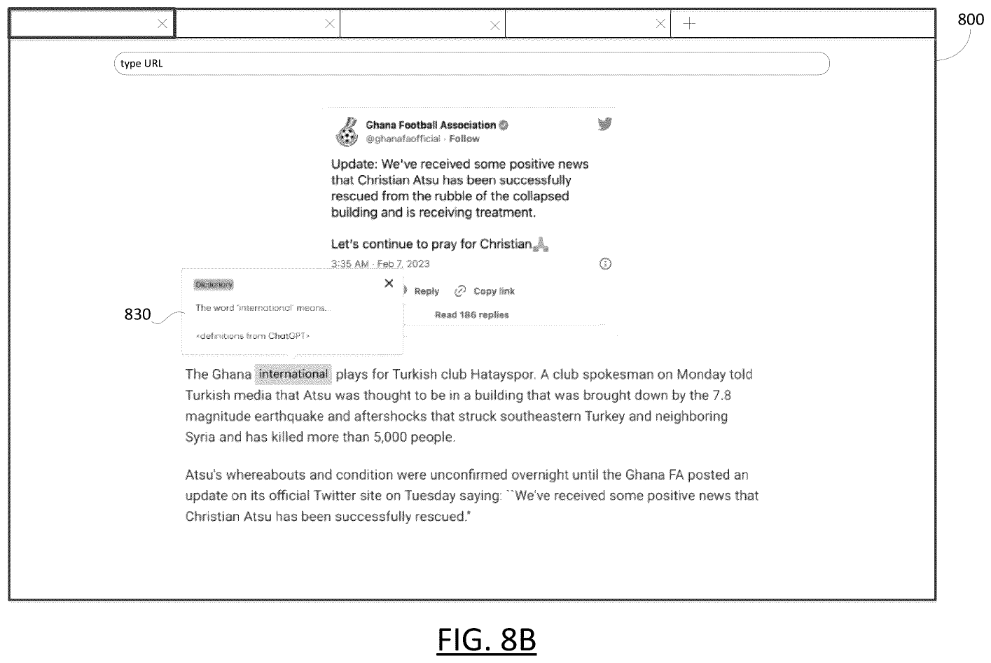

In a web browsing session, a user may encounter text content on a webpage that is desired to be simplified or defined. In operation 302, the server receives, via a client device, user selection of text content and a first request to obtain supplementary data associated with the selected text content during the web browsing session. The input of the user selection and the first request may be received via an input mechanism that is compatible with the browsing enhancement module. For example, as shown in FIG. 8A, certain text 810 on a webpage 800 may be selected by highlighting the text 810 using an input device, such as a mouse, a stylus, a keyboard, and the like. Additionally, or alternatively, text 810 on the webpage may be selected using voice command, without the use of a manual input device. The selected text may comprise a single word, a group of multiple words, one or more phrases, or all of the text on a webpage (e.g., for a page summary).

The first request may be initiated when the user performs an operation for requesting to obtain supplementary data in connection with the selected text 810. The supplementary data may comprise at least one of: a definition associated with one or more terms included in the selected text, or a summary of the selected text content. FIG. 8A shows a context menu which may appear upon user interaction with the webpage 800, such as a right-click mouse operation. The context menu includes various action options which may be available for the selected text 810. Some examples of action options include “simplify and explain”, “look up [word(s)]”, and “translate to [language]”, “edit text”, “formalize text”, etc. The option “simplify and explain” may provide a summary or other form of simplification of the selected text 810. The simplification may comprise a brief statement, abstract, etc. of important information that is contained in the selected text 810. The option “look up [word(s)]” may present, to the user, one or more definitions of the [word(s)] as determined via the browsing enhancement module. In some implementations, the “look up [word(s)]” option provides a dictionary functionality that supports defining individual words or phrases that are selected by the user.

In operation 304, the server determines whether a first database stores preferred supplementary data relating to the selected text content. The first database may be a data store in memory which is accessible by the server. In at least some implementations, the first database stores definitions of various words/phrases and summaries relating to passages of text. In particular, the first database may store supplementary data (such as definitions and summaries) of text content that was previously selected by the user. For example, the definitions and summaries may relate to text that the user selected in previous web browsing sessions. The stored definitions data for a word may include, at least, the meaning(s) of the word and context examples. In some implementations, the first database may store definitions that are imported from one or more public domain knowledge bases comprising dictionary data. For example, the first database may be populated with dictionary data which may be obtained via calls to APIs associated with one or more online dictionary services.

The server performs a check to identify any preferred definitions of selected text. A “preferred” definition of a term refers to a definition for which the user has previously indicated preference. For a given term, the user may indicate their preference and/or perceived usefulness of a definition using various input mechanisms (e.g., selection of user interface elements such as thumbs-up/-down icon, etc.). The server may track preferred definitions data across web browsing sessions and store the preferred definitions data in association with the corresponding terms in the first database. For example, preferred definitions of terms selected by the user in previous requests made by the user may be stored in the first database. The server may perform searches of the first database and compare to stored terms in order to identify suitable preferred definitions for the selected text. In some instances, a preferred definition may be a definition that is hard-coded in the first database to override alternative definitions of a term.

In some implementations, the first database may comprise a database of preferred definitions of user-selected terms. For each stored term, the server may maintain a defined number (e.g., 5) of different definitions of the term. Users can rate each definition by, for example, indicating their preference for one or more of the stored definitions. The definitions may be ranked based on the user preference data and only the preferred definitions of terms may be maintained by the server. For example, only definitions that are associated with a rating or ranking that exceeds a defined threshold may be stored in the database. Over time, the definitions having the highest ratings by the user may be prioritized in responding to user requests to define selected terms. The alternative, i.e., non-preferred, definitions of terms may be deleted. The server may obtain new definitions of terms and store them in place of the deleted definitions (up to the defined limit on number of definitions).

Additionally, or alternatively, the preferred definitions may be used as part of (i.e., included in) input prompts to a generative AI model for obtaining a new definition of a term. For example, the server may create input prompts that identify one or more definitions of a term as examples of preferred definitions for the particular user. Such input prompts may be useful for optimizing the content of the response output by the generative AI model for the user.

In response to determining that the first database does not store preferred supplementary data for the selected text, the server provides, to a generative AI model, an input prompt for generating the requested supplementary data, in operation 306. For example, if the selected word(s) are not included in the first database or if the first database does not contain preferred definitions of the selected word(s), the server determines a suitable input prompt for instructing the generative AI model to output a definition for the selected words. The input prompt includes at least a portion of the selected text and instructions for generating supplementary data (i.e., definitions, summary, etc.) associated with the selected text. The generative AI model may, for example, comprise a large language model (LLM), such as ChatGPT™ developed by OpenAI.

The generative AI model may be provided with additional relevant data. In some implementations, a UI element, such as a slider or another control component, may be presented to the user, enabling the user to select a reading level for the definition or summary that is output by the generative AI model. That is, the user may be able to select how complex the output definition/summary is to be. User input on the UI element (e.g., movement of a knob or lever along a slider) for indicating the reading level can be incorporated into the input prompt to the generative AI model.

In operation 308, the server receives an output of the generative AI model. The output may include a definition for a single word, a group of multiple words, and/or one or more phrases contained in the user-selected text. Additionally, or alternatively, the output may include a summary of a passage of text selected by the user. The server then provides the output to the user device for display thereon, in operation 310. The output may be formatted for displaying in a user interface element on the webpage. For example, a definition/summary may be provided in a dialog window (e.g., a pop-up dialog or popover) that is displayed adjacent to the selected text content. As shown in the example of FIG. 8B, a pop-up dialog 830 may indicate a selected word, a definition for the selected word that is output by the generative AI model, and a source/generator of the definition (e.g., ChatGPT). In some implementations, when an action option is selected from the context menu 820 in connection with user-selected text on a webpage, the context menu 820 may be hidden from view and a pop-up dialog 830 which contains supplementary data associated with the selected text may be displayed. The pop-up dialog 830 may be displayed, for example, as an overlay on at least a portion of the webpage content.

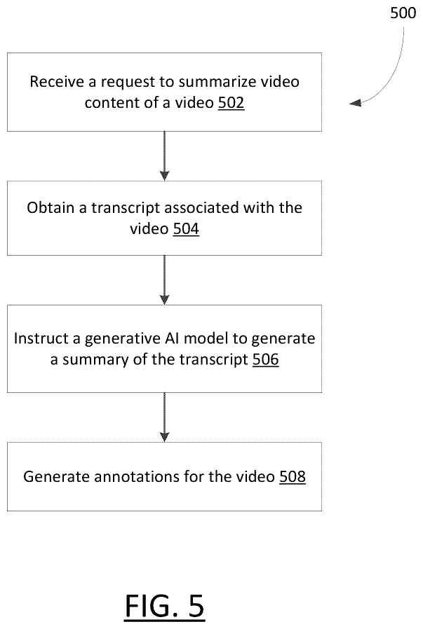

Reference is made to FIG. 4 which shows, in flowchart form, an example method 400 for processing user interaction with text content of a web document in a web browsing session. In at least some implementations, the method 400 may be implemented as part of a process for providing a user interface for accessing web documents on client devices. In particular, the operations of method 400 may be performed in providing one or more functionalities of a web browser extension that is executed locally on a client device during a web browsing session.

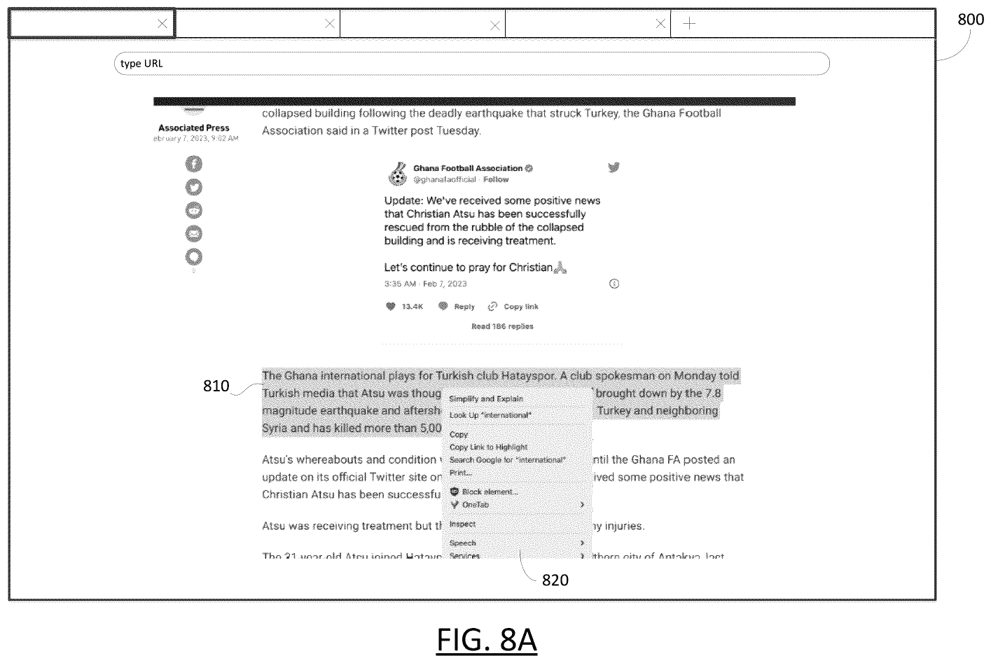

The description of method 400 provided below refers to a backend server implementing the operations of the method; however, it will be understood that one or more of the operations may be performed locally on a client device, for example, by a browsing enhancement module (e.g., a web browser extension). The operations of method 400 may be performed in addition to, or as alternatives of, one or more of the operations of method 300. FIG. 7 is a sequence diagram illustrating an example process for handling user interactions with web content, in accordance with methods 300 and 400.

In operation 402, the server receives user selection of text on a webpage and a request to provide a definition for the selected text during a web browsing session. The selected text may comprise a single word, multiple words, or one or more phrases. The text selection may be input via a user device associated with the user. For example, the selection may be made by highlighting text that is displayed on a webpage. The user can request to obtain a definition for the selected text by, for example, enabling a feature of a web browser extension for defining terms on a webpage.

The server performs a check of a database of definitions to retrieve a suitable definition for the selected term(s), in operation 404. For example, the server may query the database to request for definitions data for a selected word (or words, phrases, etc.). The database may, in some implementations, store preferred definitions for a plurality of words. The preferred definitions refer to definitions of words for which the user had previously indicated preference. The definitions may, for example, be stored from previous web browsing sessions or obtained from public domain knowledge bases comprising dictionary data. The dictionary data may be obtained via APIs associated with one or more online dictionary services. The preferred definitions may comprise a subset of the set of all definitions of words contained in the database.

In response to determining that the database stores one or more preferred definitions for the selected text (operation 406), the server presents, via the user device, one or more of the preferred definitions, in operation 408. For example, the server may determine that the database stores definitions data for a selected word and that the definitions data includes one or more definitions that are identified as being preferred for the user. The preferred definitions may be displayed on the webpage during the web browsing session. In particular, the preferred definitions may be provided in a UI element that is displayed adjacent to the selected text in the web browser GUI.

The user may interact with the definition(s) that are presented by the server. For example, the user may provide feedback to indicate whether the definitions are satisfactory or whether a different definition is desired to be obtained. The server receives user input indicating the user's preference in relation to the definitions, in operation 410. The user input may comprise selection of a UI element (e.g., thumb-up/-down icon, checkbox, radio button, etc.), responses to a prompt, text input in a text field, etc.

The database may then be updated based on the user input, in operation 412. More particularly, the server may process the user input to determine whether any changes should be made to the database in connection with the selected text. For example, if the user input indicates a preference toward the definition(s) that are presented, the database may be updated to indicate a higher rank for said definitions. Conversely, if the user indicates that the definitions are not satisfy (e.g., incorrect, overly complex, etc.), the database may be updated to delete the definitions or to assign a lower rank for said definitions. In some implementations, the server may obtain, via the generative AI model, additional definitions associated with the plurality of terms of the database and store the additional definitions in the database. For example, the server may provide, to the generative AI model, an input prompt that includes at least one of the preferred definitions.

If the database does not store preferred definitions for the selected text, the server may obtain the definitions by using a generative AI model. In some cases, use of a generative AI model may be associated with a resource cost (e.g., tokens) that is imposed to, for example, limit the length of text processed, number of queries sent to the model, and bandwidth consumed by the queries. A generative AI model may, for example, use “tokens” representing units of text that the model uses to understand and generate language. Token limits restrict the number of tokens processed in a single interaction to ensure efficient performance. A user may be allocated a limited number of tokens which count toward the requests that can be made to the generative AI model to obtain model-generated definitions.

The server verifies whether the requesting user has sufficient resources for making a request to a generative AI model (operation 414). The server may determine a total count of words included in the selected text content as part of determining if the user has sufficient resources. In response to determining that the user has sufficient resources, the server instructs the generative AI model to produce a response to the user request, in operation 416. Specifically, the server determines a suitable input prompt to provide to the generative AI model. The input prompt includes at least a portion of the selected text and instructions for generating a definition associated with the selected text. The server updates the count of the user's available resources after making the request to the generative AI model. In particular, the count may be updated to reflect the resources that were spent for making the call to the generative AI model to obtain definitions of the selected word. In operation 420, the server provides, to the user device for display thereon, the requested preferred definitions.

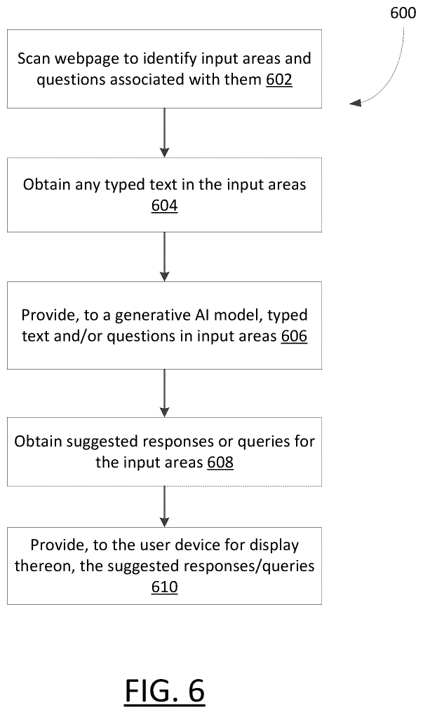

Reference is made to FIG. 5 which shows, in flowchart form, an example method 500 for processing user interaction with video content of a web document in a web browsing session. In at least some implementations, the method 500 may be implemented as part of a process for providing a user interface for accessing web documents on client devices. In particular, the operations of method 500 may be performed in providing one or more functionalities of a web browser extension that is executed locally on a client device during a web browsing session.

The description of method 500 provided below refers to a backend server implementing the operations of the method; however, it will be understood that one or more of the operations may be performed locally on a client device, for example, by a browsing enhancement module (e.g., a web browser extension). The operations of method 500 may be performed in addition to, or as alternatives of, one or more of the operations of methods 300 and 400.

A user may request, during a web browsing session, to obtain a summary of video content of a video on a webpage. Visual impairment may significantly adversely affect a user's ability to watch video content. By providing the user with supplementary data in relation to one or more videos of a webpage, the content of the webpage becomes more accessible to the user. The server receives the user request to summarize the video content, in operation 502. In some implementations, a web browser extension may include an action option for requesting a summary associated with a selected video on a webpage. Once the extension is enabled and the action option is selected by the user, the server may receive the request for a summary.

In operation 504, the server obtains a transcript associated with the video. The transcript data may be part of metadata for the video. In some implementations, the server may query a video database or request a source of the video to provide transcript data for the video. Additionally, or alternatively, the server may be configured to obtain the transcript data by using a transcribing service for automatically converting video and audio to text. The transcript may include timestamp data for indicating correspondence between the transcript text and video content of the video.

The server instructs a generative AI model to generate a summary of the transcript, in operation 506. In particular, the server produces an input prompt that includes text of the transcript and instructions to summarize the transcript. Depending on the length of the video transcript, the text of the transcript may be split across multiple different input prompts which are sent by the server to the generative AI model.

Upon receiving the output of the generative AI model, the server may annotate the video based on the generated summary of the transcript. That is, the server may augment video content of the video by generating annotations for the video. For example, the server may employ cosine similarity of adjacent sections of text to denote different sections of the video. The server may generate titles for the sections of the video, and UI elements (e.g., a buffer slider with title labels) may be provided on the client device for interacting with the section.

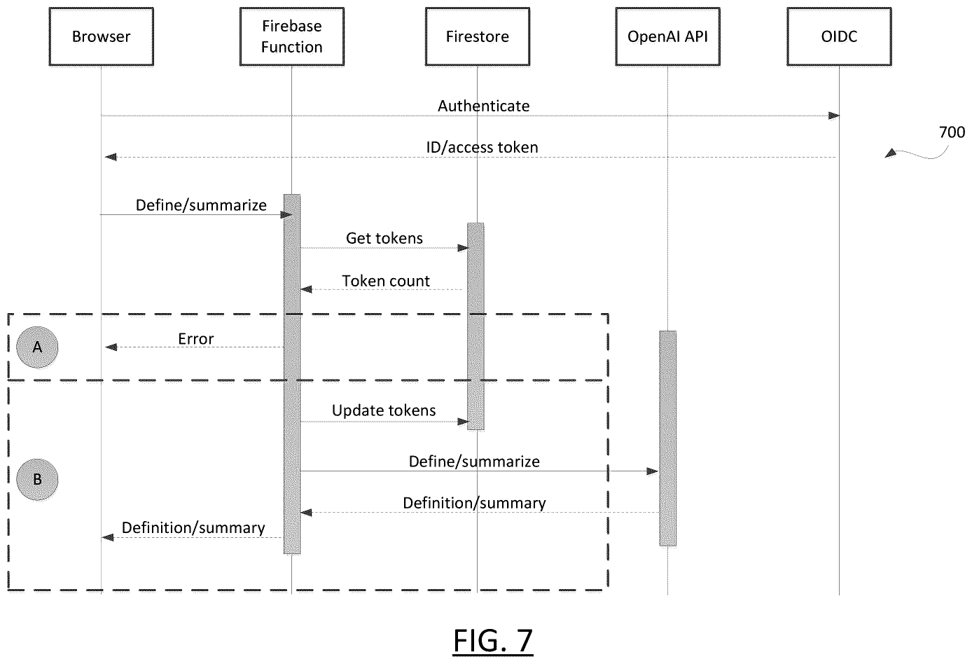

Reference is made to FIG. 6 which shows, in flowchart form, an example method 600 for managing user interface elements of a web document. In at least some implementations, the method 600 may be implemented as part of a process for providing a user interface for accessing web documents on client devices. In particular, the operations of method 600 may be performed in providing one or more functionalities of a web browser extension that is executed locally on a client device during a web browsing session.

The description of method 600 provided below refers to a backend server implementing the operations of the method; however, it will be understood that one or more of the operations may be performed locally on a client device, for example, by a browsing enhancement module (e.g., a web browser extension). The operations of method 600 may be performed in addition to, or as alternatives of, one or more of the operations of methods 300 to 500.

The server obtains document data of a web document. The web document is a document that is accessible via the Web and may, for example, be an HTML document, a static document (e.g., PDF file), an email message, and the like. The server may obtain the web document directly from a web server. For example, the server may request, via HTTP, to obtain a file that is hosted on a web server (i.e., HTTP request). The web server locates the requested document and sends the document data associated with the document in an HTTP response.

The document data of the web document includes data identifying the content items contained in the document. In at least some embodiments, the document data may comprise source code (e.g., HTML code) associated with the web document. The document data includes, for example, metadata about the web document, which may be used by the web browser for displaying content or reloading the document.

In some embodiments, the document data may be obtained in response to one or more trigger events. As explained above, a browsing enhancement module may be enabled to extend the functionalities of a web browser. In particular, a user of the client device may enable a browsing enhancement module in order to access features that are additional to a standard set of features for the web browser. The server may obtain document data for a web document in response to detecting that the browsing enhancement module has been enabled. For example, the server may determine that the browsing enhancement module is installed on the client device and receive a user input for enabling the browsing enhancement module. In response to receiving the user input, the server obtains document data for a web document.

The web document may, for example, be a document that is requested to be presented in the web browser. When the server detects that the browsing enhancement module is enabled, the server may obtain document data for a document that is requested to be displayed (e.g., a user activates a hyperlink to the document) or a document that is currently being displayed in the web browser. As the web browser retrieves the web document from a web server and processes the document data (e.g., webpage metadata) for display in the web browser, the server (in its implementation of the browsing enhancement module) may simply retrieve the document data for the web document from the web browser.

The browsing enhancement module may support predictive text generation. In operation 602, the server scans the web document to identify input areas and questions associated with them. The input areas may include UI elements, such as textboxes, that are designed to receive text input.

In operation 604, the server obtains any typed text in the input areas. That is, if there is any text currently contained in the identified input areas, the typed text may be obtained by the server. The server then provides, to a generative AI model, the typed text (if any) and/or questions in the input areas, in operation 606. The model may then be instructed to generate suggested text for use in populating the text input areas. The input prompt to the model may include the typed text as well as contextual data (e.g., input form title, descriptive text associated with the input area, inputted text in other input forms/area, etc.) along with instructions to generate the suggested text. In at least some implementations, the generative AI model may be a model that is trained using previous typed response data of the user.

In operation 608, the server obtains suggested responses or queries for the input areas. In operation 610, the server provides, to the user device for display thereon, the suggested responses/queries. For example, the suggested responses/queries may be used to automatically populate corresponding text input areas of the webpage.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a memory coupled to the processor, the memory storing computer-executable instructions that, when executed by the processor, cause the processor to:
receive, via a user device, user selection of text content and a first request to obtain supplementary data associated with the selected text content;
determine whether a first database stores preferred supplementary data relating to the selected text content;
in response to determining that the first database does not store the preferred supplementary data, provide, to a generative artificial intelligence (AI) model, an input prompt for generating the requested supplementary data, the input prompt including at least a portion of the selected text content;
receive an output of the generative AI model; and
provide, to the user device for display thereon, the output.

2. The computing system of claim 1, wherein the generative AI model comprises a large language model (LLM).

3. The computing system of claim 1, wherein the supplementary data comprises at least one of a definition associated with one or more terms included in the selected text content or a summary of the selected text content.

4. The computing system of claim 1, wherein the instructions, when executed, are to further cause the processor to:
store, in the database, a defined number of preferred definitions for a plurality of terms;
receive, via user devices, input of preference indicators in connection with the plurality of terms; and
update the stored preferred definitions of the database based on the received input of preference indicators.

5. The computing system of claim 4, wherein updating the stored preferred definitions comprises deleting one or more definitions from the database.

6. The computing system of claim 4, wherein updating the stored preferred definitions comprises obtaining, via the generative AI model, additional definitions associated with the plurality of terms and storing the additional definitions in the database.

7. The computing system of claim 6, wherein obtaining the additional definitions comprises providing, to the generative AI model, an input prompt that includes at least one of the preferred definitions.

8. The computing system of claim 1, wherein the instructions, when executed, are to further cause the processor to, prior to providing the input prompt, determine whether a requesting user has a sufficient number of tokens for making the first request, wherein the input prompt is provided to the generative AI model only if the requesting user has sufficient number of tokens.

9. The computing system of claim 8, wherein determining whether a requesting user has a sufficient number of tokens comprises determining a total count of words included in the selected text content.

10. The computing system of claim 8, wherein the instructions, when executed, are to further cause the processor to after the input prompt is provided to the generative AI model, store, in memory, an updated available token count for the requesting user.

11. The computing system of claim 1, wherein providing the output comprises displaying a user interface element containing at least a portion of the output on a graphical user interface.

12. The computing system of claim 1, wherein the selection of text content comprises at least a portion of a transcript associated with a video, and wherein the instructions, when executed, are to further cause the processor to annotate the video based on the output of the generative AI model.

13. The computing system of claim 12, wherein the annotating the video comprises generating titles for different sections of the video using the output of the generative AI model and denoting the different sections.

14. The computing system of claim 1, wherein the instructions, when executed, are to further cause the processor to display a user interface element for receiving an indication of a desired reading level for the selected text content.

15. The computing system of claim 1, wherein the instructions, when executed, are to further cause the processor to receive, via the user device, a modification request to modify the selected text content, the modification request indicating at least one of a language register or intended audience for the modified text.

16. The computing system of claim 1, wherein the instructions, when executed, are to further cause the processor to:
scanning a graphical user interface to identify one or more text input areas;
providing, to a generative AI model, an input prompt for generating suggested text for use in populating the one or more text input areas,
wherein the generative AI model is trained using previous typed response data of the user.

17. A computer-implemented method, comprising:
receiving, via a user device, user selection of text content and a first request to obtain supplementary data associated with the selected text content;
determining whether a first database stores preferred supplementary data relating to the selected text content;
in response to determining that the first database does not store the preferred supplementary data, providing, to a generative AI model, an input prompt for generating the requested supplementary data, the input prompt including at least a portion of the selected text content;
receiving an output of the generative AI model; and
providing, to the user device for display thereon, the output.

18. The method of claim 17, wherein the generative AI model comprises a large language model (LLM).

19. The method of claim 17, wherein the supplementary data comprises at least one of a definition associated with one or more terms included in the selected text content or a summary of the selected text content.

20. A non-transitory, computer-readable medium storing computer-executable instructions that, when executed by a processor, cause the processor to:
receive, via a user device, user selection of text content and a first request to obtain supplementary data associated with the selected text content;
determine whether a first database stores preferred supplementary data relating to the selected text content;
in response to determining that the first database does not store the preferred supplementary data, provide, to a generative artificial intelligence (AI) model, an input prompt for generating the requested supplementary data, the input prompt including at least a portion of the selected text content;
receive an output of the generative AI model; and
provide, to the user device for display thereon, the output.
